(19) United States
(12) Patent Application Publication
(10) Pub. No.: US 2008/0019536 A1
(43) Pub. Date: Jan. 24, 2008

(54) Method and a device for treating noise on board an aircraft

(75) Inventor: Franck Marrot, La Ciotat (FR)

Correspondence Address: YOUNG & THOMPSON, 745 SOUTH 23RD STREET, 2ND FLOOR, ARLINGTON, VA, 22202, US

(73) Assignee: EUROCOPTER, MARIGNANE CEDEX (FR)

(21) Appl. No.: 11/727,028

(22) Filed: Mar. 23, 2007

(30) Foreign Application Priority Data
Mar. 24, 2006 (FR) 06 02555

(51) Int. Cl. G10K 11/16

(52) U.S. Cl. 381/71.4

(57) ABSTRACT

The invention relates to a device for treating noise in the cabin (20) of an aircraft, the device comprising:
a plurality of microphones (22 to 24) fastened to respective seats (35) of the cabin;
a plurality of loudspeakers (26, 27);
at least one treatment unit (28) arranged to receive noise measurement signals delivered by the microphones, and to deliver control signals to the loudspeakers for the purpose of attenuating the noise in the cabin, the treatment unit comprising a plurality of treatment modules associated with respective ones of the microphones and/or of the loudspeakers; and
at least one acoustic resonator (29 to 32) including a vent (29 to 31) coupled to a cavity (32) and connecting a loudspeaker to the cabin;
the acoustic resonator including a vent (29 to 31) coupled to a cavity (32), the loudspeaker and its associated resonator presenting a frequency (33 or 34) of maximum sound level (50, 500) that is less than 1000 Hz.

The present invention relates to a method and to a device for treating noise on board an aircraft.

The technical field of the invention is manufacturing rotorcraft.

The present invention relates more particularly to systems for electronically treating noise, also known as anti-noise systems or active anti-noise systems.

Anti-noise techniques consist in general terms in measuring a noise and, as a function of the measurement, in generating a soundwave for the purpose of attenuating the noise; a distinction is generally made between feedback techniques where only one noise measurement sensor is used, and predictive or “feed forward” techniques in which a reference (correlation) signal is also used; according to the document (“Selection of active noise control strategy: two test cases” by Jari Kataja et al., Joint Baltic-Nordic Acoustics Meeting 2004, Jun. 8-10, 2004), psychoacoustic phenomena need to be taken into account when selecting the technique to use.

Proposals have been made in patents FR 2 769 396 and U.S. Pat. No. 6,224,014 to reduce spectrum line noise inside a helicopter by controlling an actuator as a function of measurements delivered by an acoustic or vibratory sensor.

Proposals have been made in patents FR 2 802 328 and U.S. Pat. No. 6,502,043 also to use a (reference) sensor taking measurements correlated with a noise source, and to weight the noise measurement signals in order to privilege determined zones of the aircraft, e.g. close to passenger seats.

The actuators used may be loudspeakers or piezoelectric actuators, and the sensors may be microphones or accelerometers. The algorithms used for minimizing noise or vibration may be of the least mean square (LMS) or of the recursive least mean square (RLMS) type.

U.S. Pat. No. 5,845,236 proposes using an active attenuator device in addition to vibratory resonators.

U.S. Pat. No. 5,754,662 proposes separately treating low frequencies and frequencies higher than the low frequencies, and separately controlling two actuators respectively adapted to said low frequencies and to said higher frequencies; in particular proposals are made to use a woofer for the low frequencies.

Patent EP 1 031 136 describes an active noise attenuator system for use inside the cabin of a helicopter that has a transmission gearbox and feet securing the gearbox to the structure of the cabin; the systems controls a plurality of actuators attached to each foot in order to apply counter-vibration thereto so as to reduce the vibration due to the gearwheels of the gearbox, at a frequency that is close to 700 hertz (Hz).

Document WO 03/073415 describes another system in which a signal weighting system is used that is variable in time in order to avoid saturating the actuators.

Patent EP 0 917 706 describes a noise attenuator system adapted to a twin-engine airplane.

Although those systems present qualities, integrating them in a rotorcraft encounters complex problems relating in particular: to the high level of the noise that needs to be attenuated; to the large quantity of “narrow” spectrum lines in the spectrum of the noise for attenuation, which lines are situated in a frequency band going up to about 10,000 Hz; and to the presence of “broad” spectrum lines in such a spectrum, in particular at frequencies situated in the range 10 Hz to 1000 Hz.

An object of the invention is to propose a method and a device for treating noise on board an aircraft, in particular a rotorcraft, that are improved and/or that remedy, at least in part, the shortcomings and the drawbacks of known systems in this field.

In accordance with an aspect of the invention, there is provided a device for treating noise in the cabin of an aircraft, the device comprising:
a plurality of microphones fastened to respective seats of the cabin;
a plurality of loudspeakers;
at least one treatment unit arranged to receive noise measurement signals delivered by the microphones, and to deliver control signals to the loudspeakers for the purpose of attenuating the noise in the cabin, the treatment unit comprising a plurality of treatment modules associated with respective ones of the microphones and/or of the loudspeakers; and
at least one acoustic resonator acoustically coupled to a loudspeaker and to the cabin;

the acoustic resonator including a vent coupled to a cavity, the loudspeaker and its associated resonator presenting a maximum sound level frequency that is less than 1000 Hz.

In accordance with another aspect of the invention, there is provided a method of attenuating noise in one or more zones of an aircraft cabin, each zone being fitted with a sensor (microphone) for measuring noise, and with a loudspeaker, the method using an attenuator device connected to the sensor(s) and to the loudspeaker(s) and designed (in particular programmed) to excite the loudspeaker(s) in such a manner as to attenuate the noise measured by the sensor(s), the aircraft being also fitted with one or more additional loudspeakers that are better adapted to delivering low frequencies than are said loudspeaker(s) fitted to the zone(s) of the cabin; the method comprising the following operations:
filtering the measurement signals delivered by the sensors to produce low frequency (LF) filtered signals and medium and high frequency (MHF) filtered signals;
generating a loudspeaker(s) control signal specific to the loudspeaker fitted to each zone of the cabin, together with an additional loudspeaker(s) control signal, said signals being generated as a function of the filtered signals and of psychoacoustic weighting, so as to attenuate the sensation of noise perceived by the occupants of the cabin; and
increasing the sound level from the additional loudspeaker(s) by an acoustic resonator coupled to the additional loudspeaker and to the cabin.

According to another aspect of the invention, a method is proposed for attenuating noise on board an aircraft having a cabin fitted with one or more loudspeaker(s) and one or more microphone(s) for measuring noise, the method comprising the following steps:
filtering the signals from the microphone(s) to extract low frequency components of the noise and generating a loudspeaker control signal at least from the filtered signals so as to attenuate the sensation of noise perceived by the occupants of the cabin; and
coupling the loudspeaker to the cabin via an acoustic adapter improving the efficiency of the loudspeaker at low frequency.

According to another aspect of the invention, there is provided a device for treating noise in the cabin (which can include the cockpit) of a rotorcraft, the device comprising:
at least one microphone, preferably secured to a respective seat;
at least one loudspeaker;
a treatment unit that is connected to the microphone(s) to receive noise measurement signals therefrom, and that is connected to the loudspeaker(s) to deliver control signals thereto enabling noise in the cabin to be attenuated; and
an acoustic adapter connecting a loudspeaker to the cabin, the adapter comprising a cavity that is acoustically coupled to the loudspeaker together with a duct or vent putting the cavity into communication with the cabin.

The adapter comprising the duct (vent) connecting the cavity to the cabin serves to improve the efficiency of the loudspeaker in the vicinity of low frequencies that are preferably below 1000 Hz, in particular that lie in a range going from about 10 Hz to about 100 Hz, or in a range about 30 Hz to about 300 Hz.

Preferably, the device has a plurality of microphones and a plurality of loudspeakers; each vent may be substantially cylindrical in shape or it may be tapering, being convergent and/or divergent in shape.

In an embodiment, two vents respectively associated with two cavities (and with two loudspeakers) present two respective frequencies of maximum efficiency (in terms of sound levels) having values that are different.

The invention may be implemented by means of a program.

Thus, according to an aspect of the invention, there is provided a program for treating data corresponding to noise measurements in order to deliver loudspeaker control data, the program being written in a medium, such as an optionally removable memory, that is readable by a computer or processor of the treatment unit that is on board or that is suitable for mounting on board the aircraft, and that is arranged, on being executed by said computer or processor, to perform the operations of a method of the invention.

Other aspects, characteristics, and advantages of the invention appear on reading the following description that refers to the accompanying drawings and that illustrates, without any limiting character, preferred embodiments of the invention.

Unless specified to the contrary, the terms “signal” and “data” are considered as being equivalent.

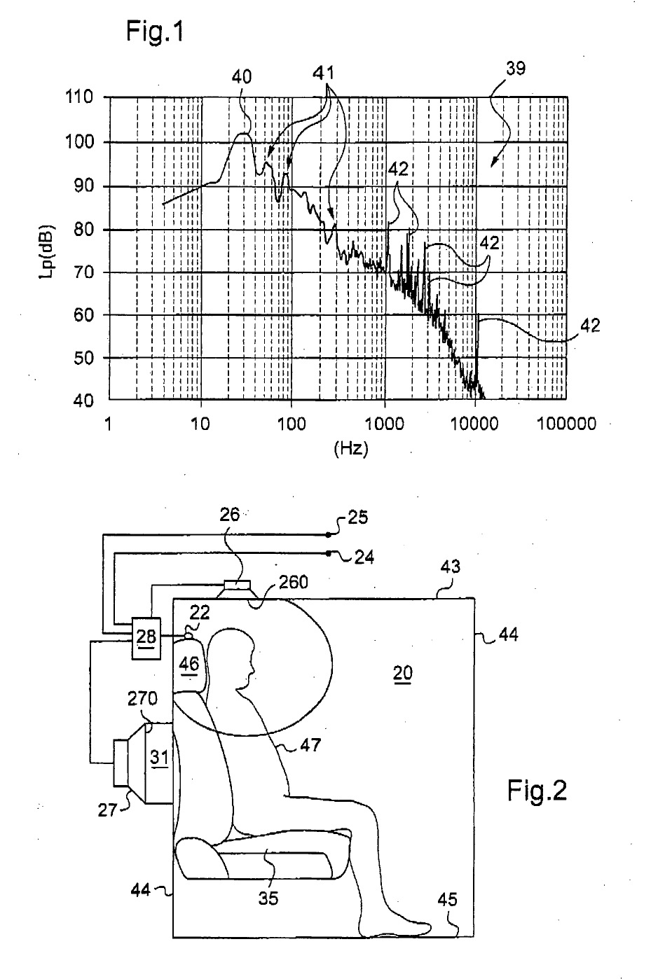

FIG. 1 is a graph showing a spectrum of the noise produced by a helicopter, with frequency being plotted along the abscissa axis on a logarithmic scale and with noise level (in dB) being plotted up the ordinate axis with a linear scale.

FIG. 2 is a diagram showing a first embodiment of a device of the invention.

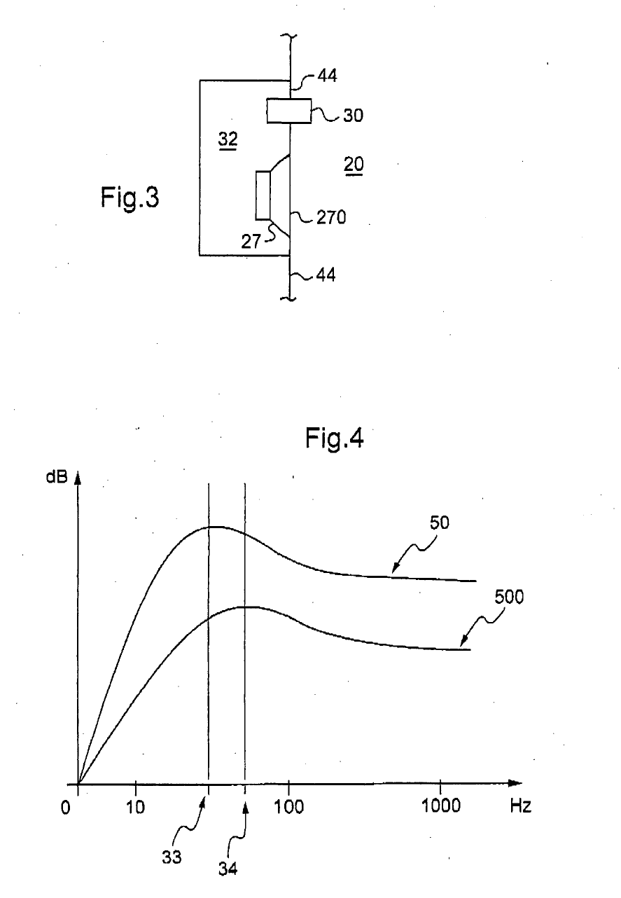

FIG. 3 is a diagram showing a variant embodiment of an acoustic adapter of a device of the invention.

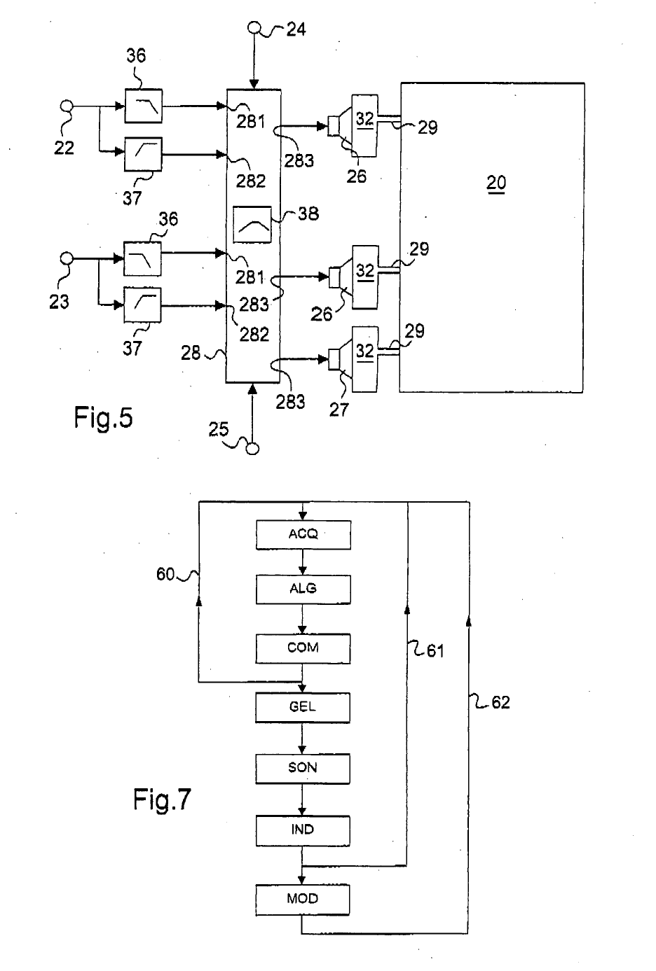

FIG. 4 is a graph showing diagrammatically variations as a function of frequency in the sound level from a loudspeaker coupled to an adapter in a device of the invention.

FIG. 5 is a diagram of a second embodiment of a device of the invention.

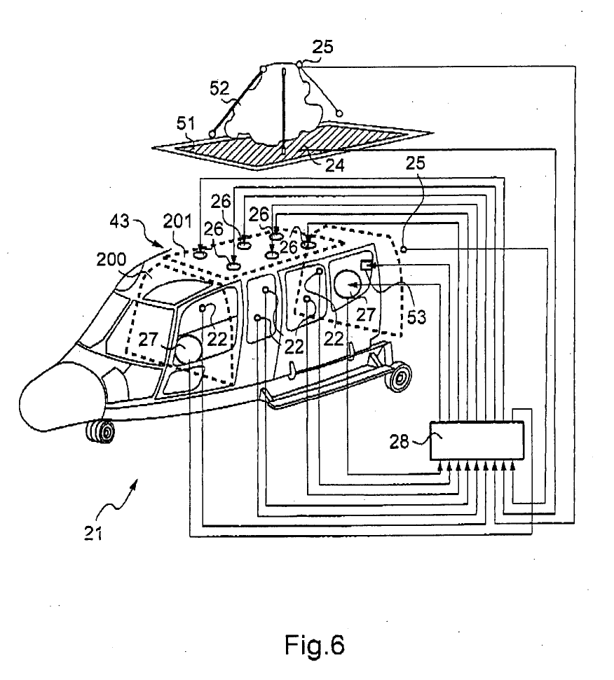

FIG. 6 is a diagram of a third embodiment of a device of the invention and how it is integrated in a helicopter that is shown in part in an exploded view.

FIG. 7 is a diagram showing the sequences of operations of programs and methods of the invention.

With reference to FIG. 1, the spectrum 39 of the noise that exists in the cabin of a helicopter presents a level that increases up to a maximum 40 that exceeds 100 decibels (dB) for frequencies in the vicinity of 20 Hz to 40 Hz; the general trend of noise level (“background noise”) decreases for higher frequencies, including “broad” spectrum lines 41 centered on frequencies of about 50 Hz to 400 Hz, followed by “narrow” spectrum lines 42 centered on frequencies of the order of 500 Hz to 10,000 Hz.

With reference to FIG. 2, the cabin 20 is defined by ceiling panels 43, partition panels 44, and floor panels 45; a seat 35 provided with a headrest 46 is fitted in the cabin and receives a passenger 47.

A loudspeaker 26 is secured to the ceiling panel 43 so that the front face of its diaphragm 260 can radiate directly into the cabin. A second loudspeaker 27 is secured to the partition panel 44 via a duct 31; the front face of the diaphragm 270 of the loudspeaker 27 extends at the left-hand end (in the figure) of the duct 31, which has its right-hand end opening out into the cabin.

A microphone 22 is secured to the headrest 46 and is connected, as are the loudspeakers 26 and 27, to a signal and data processor unit 28. A sensor 25, such as a tachometer sensitive to the frequency of rotation of the main rotor of the helicopter, and/or a microphone or an accelerometer 24 are also connected to the unit 28 to supply it with a reference signal.

In the configuration shown in FIG. 5, the device has two microphones 22 and 23 serving to measure the noise in two zones of the cabin where the sensation of noise needs to be minimized. Each microphone is connected to the unit 28 via a lowpass filter 36 and a highpass filter 37, such that the unit 28 receives on its inputs 281 filtered noise measurement signals of low frequency, and receives on its inputs 282 filtered noise measurement signals of medium and high frequency.

By way of example, the cutoff frequency of the filters 36 and 37 may be about 300 Hz to 600 Hz approximately.

The filters 36, 37 may be digital and/or integrated in the unit 28.

On the basis of the signals delivered by the sensors 22 to 25, the unit 28 generates control signals that it delivers to its outputs that are connected to the loudspeakers 26, 27.

In the configuration shown in FIG. 5, a cavity 32 extends in front of the diaphragm of each loudspeaker 26, 27; in addition, each cavity 32 is connected via a respective tubular vent 29 to the cabin 20.

In the configuration of FIG. 3, the cavity 32 extends behind the diaphragm 270 of the loudspeaker 27; a vent 30 extends through the wall 44 separating the cavity 32 from the cabin, and connects the cavity to the volume of the cabin.

The sound level from the loudspeaker at low frequencies, in particular in the vicinity of the frequencies 33 or 34 is not high enough to be capable of effectively attenuating the broad spectrum lines 40, 41 (cf. FIG. 1) in the helicopter noise. The cavity and the vent form an acoustic resonator (of the Helmholtz type) connecting the loudspeaker to the cabin; the assembly formed by the loudspeaker and the resonator constitutes a bass-reflex system which, as shown in FIG. 4, presents efficiency (50) that varies as a function of frequency.

When two zones of the cabin are treated, each by means of a respective loudspeaker, the two loudspeakers fitted with their respective resonators present maximum sound levels for the low frequencies 33 or 34 respectively; these frequencies 33, 34 correspond to the acoustic characteristics of the two zones and they are generally less than 100 Hz. The amplification obtained makes it possible to attenuate the spectrum lines 40 or 41 effectively.

In an embodiment, a first loudspeaker connected to the cabin via a first adapter presents the sound level 50, while a second loudspeaker connected to the cabin by a second adapter presents the sound level 500; it should be observed that these two sound level curves (50 or 500) present respective maxima at two different frequency values.

In the configuration shown in FIG. 6, the device includes one microphone 22 placed in the cockpit 200 of the helicopter 21 and four other microphones 22 secured to the seats (not shown) fitted to the main cabin 201; a loudspeaker 27 secured to the partition separating the cockpit from the cabin enables noise in the cockpit to be attenuated.

Six loudspeakers 26 are fitted to a ceiling trim panel of the cabin 201, and a loudspeaker 27 is fitted to a rear panel of the cabin. At least one of the loudspeakers is used for (interphone) communication between the crew and the passengers.

The device also has two reference sensors (accelerometers) 24, 25 respectively secured to a structure 51 (“transmission support structure”) receiving the main transmission gearbox 52 of the helicopter, and to said gearbox.

The device also has an electromechanical resonator or vibrator 53 secured to the structure of the helicopter and controlled by the unit 28 for attenuating noise in the cabin 200, 201; an additional reference sensor 25 is secured close to the resonator and is connected to one of the inputs of the unit 28.

With reference to FIG. 5, the unit 28 for processing the signals delivered by the sensors includes a psychoacoustic weighting module 38; this module weights noise signals or data input to the unit 28, and/or weights control signals or data for the loudspeakers; this weighting makes it possible to optimize one or more sound comfort parameters, in particular loudness or level in dBA, dBG, or dBSIL4.

This weighting may be implemented by a method or program executed by a processor of the unit 28 and including the following sequence (cf. FIG. 7):
acquiring (ACQ) noise signals delivered by the sensors 22 to 24;
adapting (ALG) the coefficients of the filter delivering the control signals to the loudspeakers, as a function of the measured noise signals, using a least mean square (LMS) or a recursive least mean square (RLMS) algorithm;
generating (COM) control signals for the loudspeakers enabling sound waves to be generated in phase opposition to those corresponding to the measured noise;
so long as control signal generation does not converge towards a stable solution, executing of the ACQ/ALG/COM sequence of operations repeatedly (branch 60), and once stability has been achieved, the sequence is followed by:
recording GEL the coefficients of the filters;
calculating SON psychoacoustic parameters (e.g. loudness and acuity) as a function of the measured noise signals; and
calculating and storing IND a sound comfort index or level;

if the comfort index as obtained in this way is greater than or equal to the index previously obtained by the same sequence of operations, then execution of the ACQ to IND sequence of operations is repeated (branch 61), otherwise the method involves replacing MOD the most recently recorded filter coefficients with the previously recorded coefficients, and restarting (branch 62) execution of the complete sequence of operations ACQ to MOD.

The efficiency of the device of the invention results in particular from using loudspeakers and acoustic adapters that are adapted to the frequency band in which the noise level corresponds to a large amount of energy; this efficiency can be reinforced by separately controlling firstly loudspeakers that are adapted to low frequencies, and secondly loudspeakers that are adapted to medium and high frequencies.

Furthermore, using psychoacoustic weighting makes it possible to avoid pointlessly attenuating those components of noise that produce a lesser sensation of discomfort.

These characteristics contribute to obtaining a system that is lighter in weight and more suitable for being fitted on board an aircraft.

1. A device for treating noise in the cabin (20, 200, 201) of an aircraft (21), the device comprising:
a plurality of microphones (22 to 24) fastened to respective seats (35) of the cabin;
a plurality of loudspeakers (26, 27);
at least one treatment unit (28) arranged to receive noise measurement signals delivered by the microphones, and to deliver control signals to the loudspeakers for the purpose of attenuating the noise in the cabin, the treatment unit comprising a plurality of treatment modules associated with respective ones of the microphones and/or of the loudspeakers; and
at least one acoustic resonator (29 to 32) acoustically coupled to a loudspeaker and to the cabin;
the acoustic resonator including a vent (29 to 31) coupled to a cavity (32), the loudspeaker and its associated resonator presenting a frequency (33 or 34) of maximum sound level (50, 500) that is less than 1000 Hz.

2. A device according to claim 1, in which the frequency of maximum sound level is situated in a range from about 10 Hz to about 100 Hz.

3. A device according to claim 1, in which the frequency of maximum sound level is situated in a range from about 20 Hz to about 300 Hz.

4. A device according to claim 1, in which the vent is substantially cylindrical in shape or is tapering, being convergent and/or divergent in shape.

5. A device according to claim 1, in which two vents respectively associated with two cavities and with two loudspeakers form two resonators presenting two different respective maximum sound level frequencies (33 or 34).

6. A device according to claim 1, including a member (36, 37) for filtering signals delivered by the microphone(s), and a plurality of modules of the treatment unit for producing both low frequency signals and also medium and high frequency signals.

7. A device according to claim 1, in which the treatment unit includes a member (38) for psychoacoustically weighting signals received from the microphones or delivered to the loudspeakers.

8. A device according to claim 1, further including an electromechanical vibrator (53) secured to the structure of the helicopter and controlled by the unit (28) to attenuate noise in the cabin.

9. A method of attenuating noise on board an aircraft (21) having a cabin (20, 200, 201) fitted with a plurality of loudspeakers (26, 27) and a plurality of noise measurement sensors (22 to 24), the method comprising the following steps:
filtering the signals from each sensor to extract low frequency noise components and generating a loudspeaker control signal at least on the basis of the filtered signals in order to attenuate the sensation of noise perceived by the occupants of the cabin; and
coupling the loudspeaker to the cabin via an acoustic resonator (29 to 32) improving the efficiency of the loudspeaker at low frequencies, the acoustic resonator having a vent (29 to 31) coupled to a cavity (32), the loudspeaker and its associated resonator presenting a frequency (33 or 34) of maximum sound level (50, 500) that is less than 1000 Hz.

10. A method according to claim 9, for attenuating noise in a plurality of zones in the cabin, each zone being fitted with a microphone and with a loudspeaker, by using an attenuating device connected to the microphones and to the loudspeakers and programmed to excite the loudspeakers so as to attenuate the noise measured by the microphones, at least one loudspeaker being acoustically coupled to the cabin via a resonator comprising a cavity and a vent, the method comprising the following steps:
filtering measurement signals delivered by the microphones to produce low frequency (LF) filtered signals and medium and high frequency (MHF) filtered signals;
generating a loudspeaker control signal specific to the loudspeaker fitted to each zone of the cabin, the loudspeaker control signals being generated as a function of the filtered signals and as a function of psychoacoustic weighting in order to attenuate the sensation of noise perceived by the occupants of the cabin.

11. A program for treating noise measurement data inside an aircraft in order to deliver loudspeaker control data for the purpose of reducing noise, which program is written in a medium that is readable by a processor on board the aircraft, and that is arranged, on being executed by the processor, to perform operations of a method according to claim 9.

12. A program according to claim 11, that is arranged, on being executed by the processor, to perform psychoacoustic weighting of the noise measurement data or of the loudspeaker control data.

13. A program according to claim 11, that treats in parallel noise measurement data delivered by a plurality of sensors and/or control data for a plurality of loudspeakers.

14. A program according to claim 11, including a module for frequency filtering noise measurement data.

15. A program according to claim 11, including a noise minimizing algorithm of the LMS or RLMS type.

16. A program according to claim 11, using signals delivered by a tachometer (25) sensitive to the frequency of rotation of a rotor.

17. A device for treating noise in the cabin (20, 200, 201) of an aircraft (21), the device comprising:
a plurality of microphones (22 to 24) fastened to respective seats (35) of the cabin;
a plurality of loudspeakers (26, 27);
at least one treatment unit (28) arranged to receive noise measurement signals delivered by the microphones, and to deliver control signals to the loudspeakers for the purpose of attenuating the noise in the cabin, the treatment unit comprising a plurality of treatment modules associated with respective ones of the microphones and/or of the loudspeakers; and
at least one acoustic resonator (29 to 32) acoustically coupled to a loudspeaker and to the cabin;
the acoustic resonator including a vent (29 to 31) coupled to a cavity (32), the loudspeaker and its associated resonator presenting a frequency (33 or 34) of maximum sound level (50, 500) that is less than 1000 Hz,
and in which the treatment unit includes a member (38) for psychoacoustic weighting of the signals received from the microphones or the signals delivered to the loudspeakers.

18. A device according to claim 17, in which two vents respectively associated with two cavities and with two loudspeakers form two resonators presenting two different respective maximum sound level frequencies (33 or 34).

19. A device according to claim 17, further including an electromechanical vibrator (53) secured to the structure of the helicopter and controlled by the unit (28) to attenuate noise in the cabin.

20. A device according to claim 17, in which the vent is substantially cylindrical in shape or is tapering, being convergent and/or divergent in shape.
